(19) United States
(12) Patent Application Publication
(10) Pub. No.: US 2021/0347324 A1
(43) Pub. Date: Nov. 11, 2021

(54) Partitioned Golf Cart and Related Methods

(71) Applicant: Doug Borgsdorf, Richmond, IN (US)

(72) Inventor: Doug Borgsdorf, Richmond, IN (US)

(73) Assignee: Primex Plastics Corporation, Richmond, IN (US)

(21) Appl. No.: 17/314,084

(22) Filed: May 7, 2021

Related U.S. Application Data
(60) Provisional application No. 63/021,438, filed on May 7, 2020.

(51) Int. Cl. B60R 21/06

(52) U.S. Cl. CPC B60R 21/06; B60Y 2200/23

(57) ABSTRACT

A golf cart having a golf cart having a driver side, a passenger side, a front-end portion, a rear-end portion, and a roof; a flexible plastic sheet that partitions the golf-cart driver side from the golf-cart passenger side; the flexible plastic sheet having a first-corner portion that is attached to the golf-cart front-end portion; the flexible plastic sheet having a second-corner portion that is attached to the golf-cart rear-end portion; and the flexible plastic sheet having an edge portion that is attached to the golf-cart roof.

### CROSS-REFERENCE TO RELATED APPLICATIONS

This non-provisional patent application claims priority to U.S. provisional patent application Ser. No. 63021438 filed on May 7, 2020. All of the subject matter from U.S. provisional patent application Ser. No. 63021438 is incorporated into this patent application by reference.

### BACKGROUND OF THE INVENTION

Golf carts are very well known, and they are used on golf courses all around the world.

In view of the current pandemic, there remains a need for protecting both a golf-cart driver and a golf-cart passenger from acquiring the COVID-19 coronavirus from one another. There remains a need to reduce the risk of spreading the COVID-19 coronavirus.

### BRIEF SUMMARY OF THE INVENTION

A golf cart having a driver side, a passenger side, a front-end portion, a rear-end portion, and a roof; a flexible plastic sheet that partitions the golf-cart driver side from the golf-cart passenger side; the flexible plastic sheet having a first-corner portion that is attached to the golf-cart front-end portion; the flexible plastic sheet having a second-corner portion that is attached to the golf-cart rear-end portion; and the flexible plastic sheet having an edge portion that is attached to the golf-cart roof.

A golf cart having a driver side, a passenger side, and a roof; a flexible plastic sheet that partitions the golf-cart driver side from the golf-cart passenger side, wherein the flexible plastic sheet is configured to roll up into a stowed position that is adjacent to and underneath the golf-cart roof; the flexible plastic sheet having an edge portion that is attached to the golf-cart roof; the golf cart having at least one tie configured to secure the flexible plastic sheet in the stowed position.

A golf-cart partition having a flexible plastic sheet configured to partition a golf-cart driver side from a golf-cart passenger side; the flexible plastic sheet being substantially rectangular and having two opposing edges of a first length and two opposing edges of a second length, the first length being greater than the second length; first and second edges that are opposing and that have the first length, the first and second edges having respectively been formed by folding the flexible plastic sheet back upon itself one time and secured into the resulting folded position; a third edge having the second length and having been formed by folding the flexible plastic sheet back upon itself one time and secured into the resulting folded position; the flexible plastic sheet having first and second corners, the first corner being formed by the first edge meeting the third edge and the second corner being formed by the second edge meeting the third edge; a first grommet in immediate proximity to the first corner; a second grommet in immediate proximity to the second corner; the first and second grommet both being configured to allow a bungee cord to pass therethrough; a first hook-and-loop fastener strip being attached to the fourth edge and configured to mate with a second hook-and-loop fastener strip; the flexible plastic sheet having a first and second side, the first side having a third hook-and-loop fastener strip attached thereto; and the third hook-and-loop fastener strip configured to contact and mate with a fourth hook-and-loop fastener strip that is attached to the second side of the flexible plastic sheet when the flexible plastic sheet is in a rolled-up configuration.

A golf-cart partition having a flexible plastic sheet configured to partition a golf-cart driver side from a golf-cart passenger side; the flexible plastic sheet being substantially rectangular and having two opposing edges of a first length and two opposing edges of a second length, the first length being greater than the second length; first and second edges that are opposing and that have the first length, the first and second edges having respectively been formed by folding the flexible plastic sheet back upon itself one time and secured into the resulting folded position; a third edge having the second length and having been formed by folding the flexible plastic sheet back upon itself one time and secured into the resulting folded position, wherein at least one wire is inside of the resulting folded position; the flexible plastic sheet having first and second corners, the first corner being formed by the first edge meeting the third edge and the second corner being formed by the second edge meeting the third edge; a first hook-and-loop fastener strip being attached to the fourth edge and configured to mate with a second hook-and-loop fastener strip; the flexible plastic sheet having a first and second side, the first side having a third hook-and-loop fastener strip attached thereto; and the third hook-and-loop fastener strip configured to contact and mate with a fourth hook-and-loop fastener strip that is attached to the second side of the flexible plastic sheet when the flexible plastic sheet is in a rolled-up configuration.

### BRIEF DESCRIPTION OF THE SEVERAL VIEWS OF THE DRAWING

FIG. 01 is a side perspective view of an embodiment.

FIG. 01A is a side perspective view that shows a magnified portion of an embodiment.

FIG. 01B is a side perspective view of an embodiment.

FIG. 01C is a side perspective view of an embodiment.

FIG. 02 is a side perspective view of an embodiment.

FIG. 02A is a side perspective view that shows a magnified portion of an embodiment.

FIG. 03 is a front view of a flexible plastic sheet embodiment.

FIG. 03A is a perspective view showing both sides a flexible-plastic-sheet embodiment.

FIG. 03B is a front view that shows a magnified portion of a flexible-plastic-sheet embodiment.

FIG. 04 is a front view of a flexible-plastic-sheet embodiment.

FIG. 04A is a front view that shows a magnified portion of a flexible-plastic-sheet embodiment.

FIG. 04B is a front view that shows a magnified portion of a flexible-plastic-sheet embodiment.

FIG. 04C is a front view that shows a magnified portion of a flexible-plastic-sheet embodiment.

FIG. 04D is a backside view of a flexible-plastic-sheet embodiment.

FIG. 04E is a backside view that shows a magnified portion of a flexible-plastic-sheet embodiment.

FIG. 04F is a backside view of a flexible-plastic-sheet embodiment.

FIG. 04G is a backside view that shows a magnified portion of a flexible-plastic-sheet embodiment.

FIG. 05 is a side perspective view of an embodiment.

FIG. 05A is a side perspective view of an embodiment.

### DETAILED DESCRIPTION OF THE INVENTION

Generally provided are embodiments directed to a golf cart having a partition that partitions the golf-cart driver side from the golf-cart passenger side. The partitioned golf-cart embodiments are described below with reference to the figures.

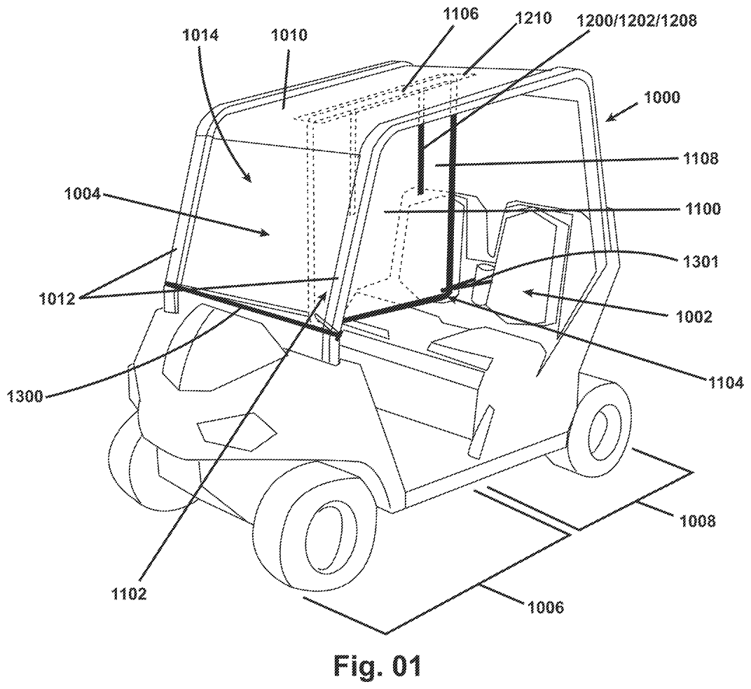

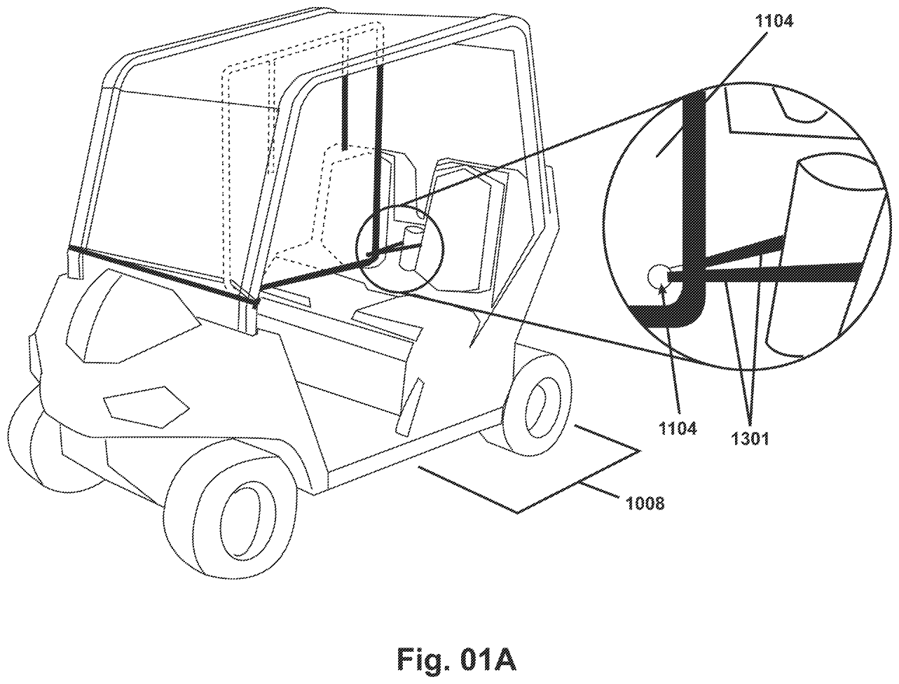

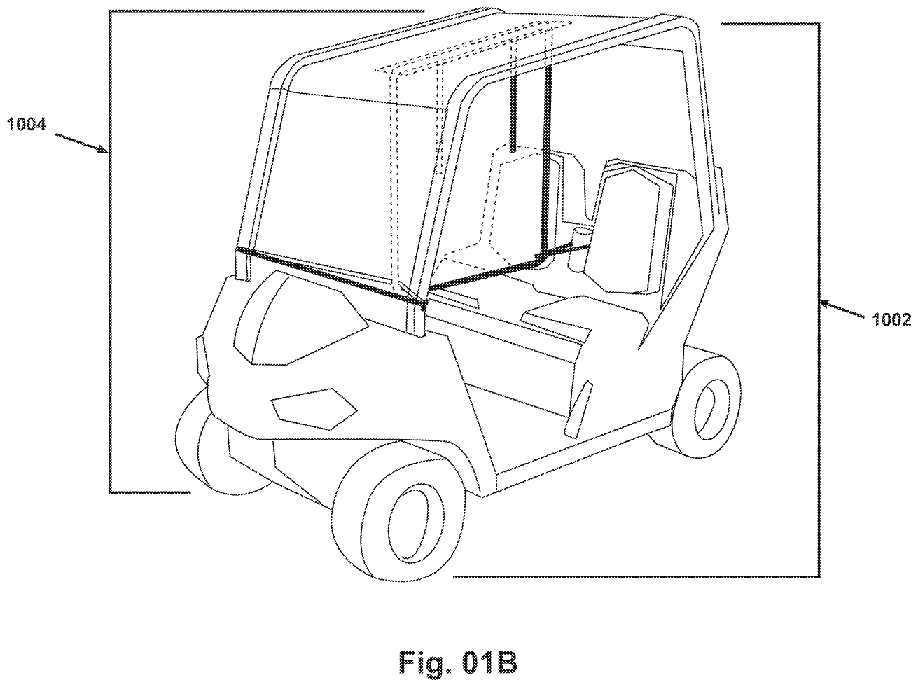

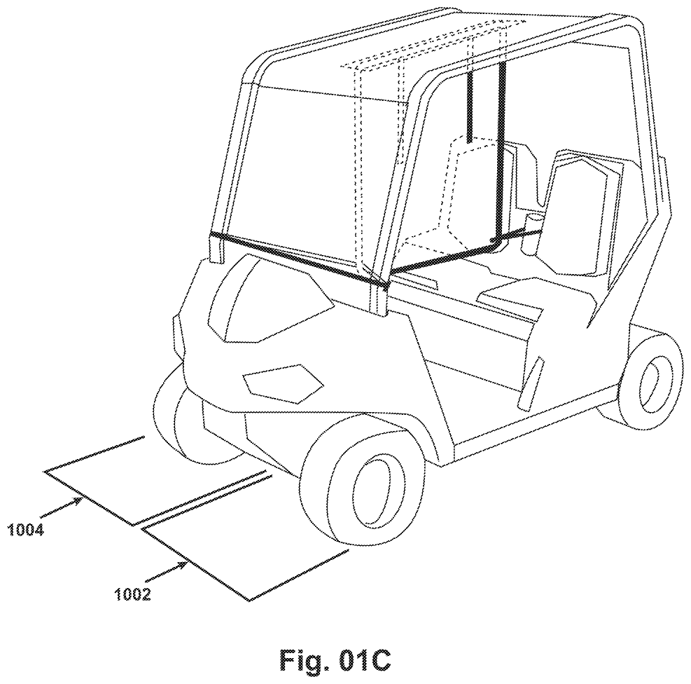

FIG. 01 is a side perspective view showing golf cart 1000 having golf-cart driver side 1002 partitioned from golf-cart passenger side 1004 by flexible plastic sheet 1100. In this embodiment, flexible plastic sheet 1100 is attached to golf cart 1000 at three different golf-cart locations: at golf-cart front-end portion 1006, at golf-cart rear-end portion 1008, and at golf-cart roof 1010. Golf-cart front-end portion 1006 and golf-cart rear-end portion 1008 are described with brackets that respectively identify the front-half portion of golf cart 1000 and the rear-half portion of golf cart 1000. More specifically, flexible-plastic-sheet first-corner portion 1102 is shown as being attached to golf-cart front-end portion 1006 using front-end bungee cord 1300 that is wrapped around a lower portion of both golf-cart front-viewing frames 1012 (golf-cart front-viewing frames 1012 describe golf-cart front-viewing area 1014); flexible-plastic-sheet second corner portion 1104 is attached to golf-cart rear-end portion 1008 using rear-end bungee cord 1301 that is wrapped around a golf-cart component located in the golf-cart rear-end portion 1008; flexible-plastic-sheet edge portion 1106 is attached to golf-cart roof 1010. Attached to flexible plastic sheet 1100 is tie 1200 that is configured to secure flexible plastic sheet 1100 when flexible plastic sheet 1100 is rolled up and in a stowed position; in embodiments, tie 1200 is hook-and-loop fastener tie 1202.

FIG. 01A shows a magnified view of flexible-plastic-sheet grommet 1104 through which rear-end bungee cord 1301 passes and thereby attaches flexible-plastic-sheet second-corner portion 1104 to golf-cart rear-end portion 1008.

FIG. 01B and 01C both provide illustrations of golf-cart driver side 1002 and golf-cart passenger side 1004; in FIG. 01B, brackets are used in one way to identify each of the sides, and in FIG. 01C, brackets are used in a different way to show each of the sides, i.e., golf-cart driver side 1002 and golf-cart passenger side 1004.

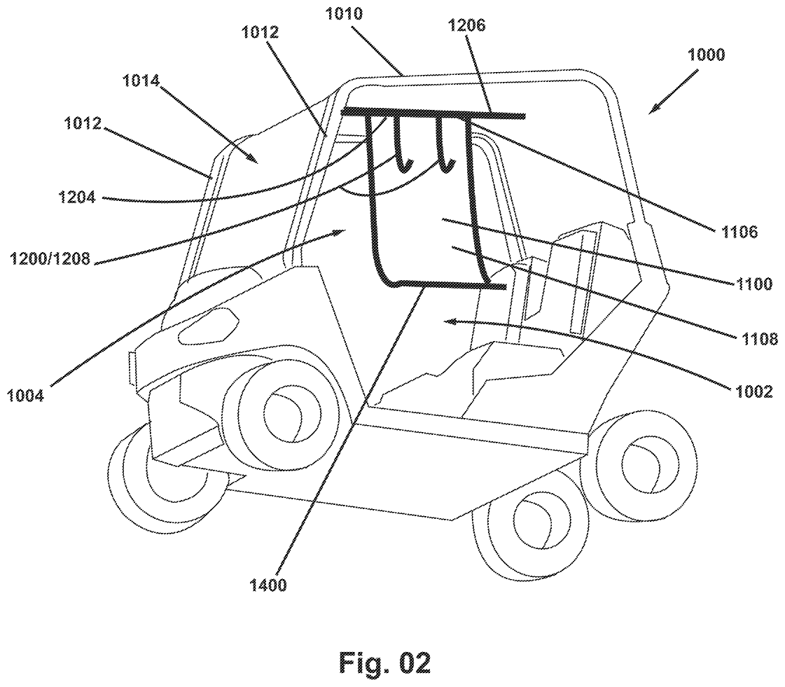

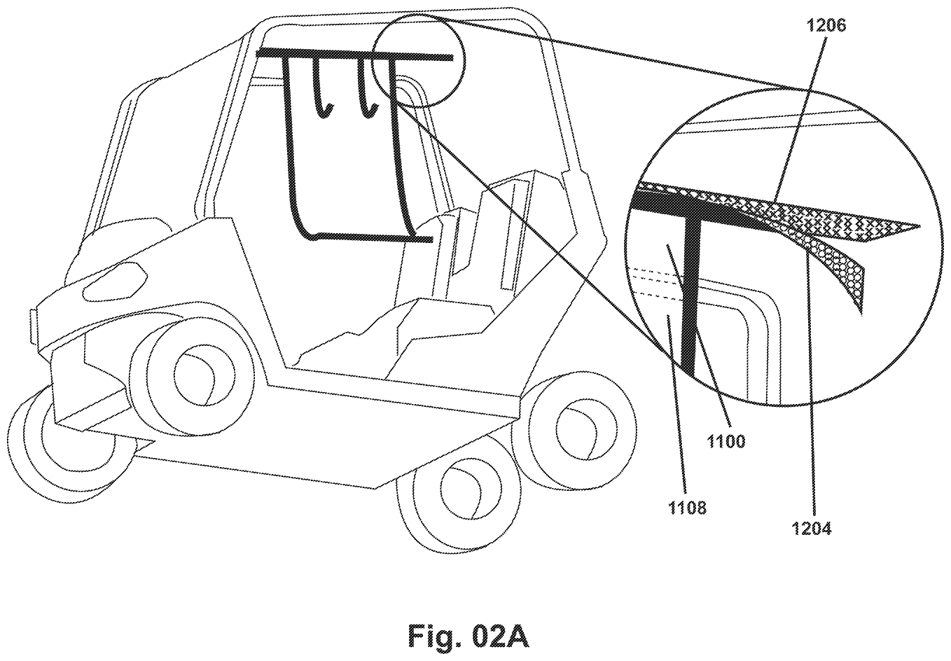

FIG. 02 is a side perspective view showing golf cart 1000 having golf-cart driver side 1002 partitioned from golf-cart passenger side 1004 by flexible plastic sheet 1100. In this embodiment, flexible plastic sheet 1100 is attached to golf cart 1000 at a single site of attachment- golf-cart roof 1010. In this embodiment, flexible plastic sheet 1100 is attached to golf-cart roof 1010 using first hook-and-loop fastener strip 1204 that is attached flexible plastic sheet 1100; first hook-and-loop fastener strip 1204 is mated with second hook-and-loop fastener strip 1206 that is attached to the underside of golf-cart roof 1010; the two mated hook-and-loop fastener strips thereby attach flexible plastic sheet 1100 to the underside of golf-cart roof 1010. More precisely, it is flexible-plastic-sheet edge portion 1106 that is attached to golf-cart roof 1010 using the mated first and second hook-and-loop fastener strips 1204, 1206. As in the previously described embodiment, tie 1200 is attached to flexible plastic sheet 1100. Tie 1200 is configured to secure flexible plastic sheet 1100 when flexible plastic sheet 1100 is rolled up and in a stowed position. In embodiments, tie 1200 is third hook-and-loop fastener strip 1208 that secures flexible plastic sheet 1100 in a stowed position as flexible plastic sheet 1100 is rolled up into a stowed position adjacent to the underside of golf-cart roof 1010; as illustrated in the figures, during the process of being rolled up into a stowed position, third and fourth hook-and-loop fastener strips 1208,1210 mate and thereby secure the position of the rolled up and stowed flexible plastic sheet 1100. As further shown in FIG. 02 and the other figures, at least one substantially straight wire 1400 is enveloped in the lowest hanging edge portion of flexible plastic sheet 1100 to assist this lowest hanging edge portion in maintaining a substantially straight edge.

FIG. 02A shows a magnified view of first hook-and-loop fastener strip 1204 being mated with second hook-and-loop fastener strip 1206 to thereby attach flexible plastic sheet 1100 to golf-cart roof 1010.

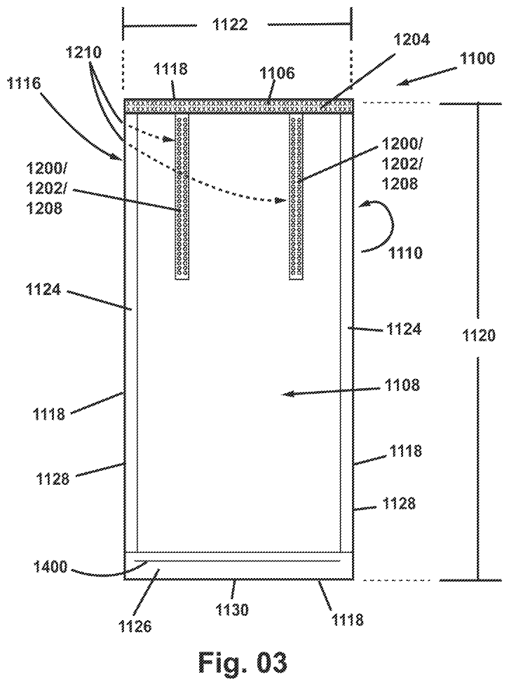

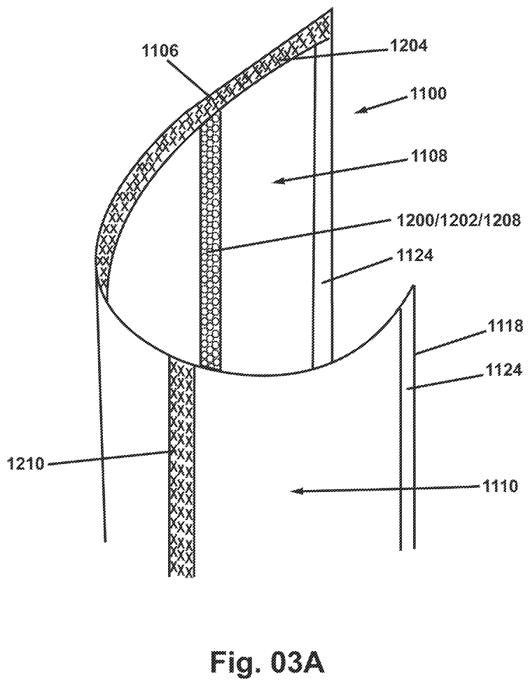

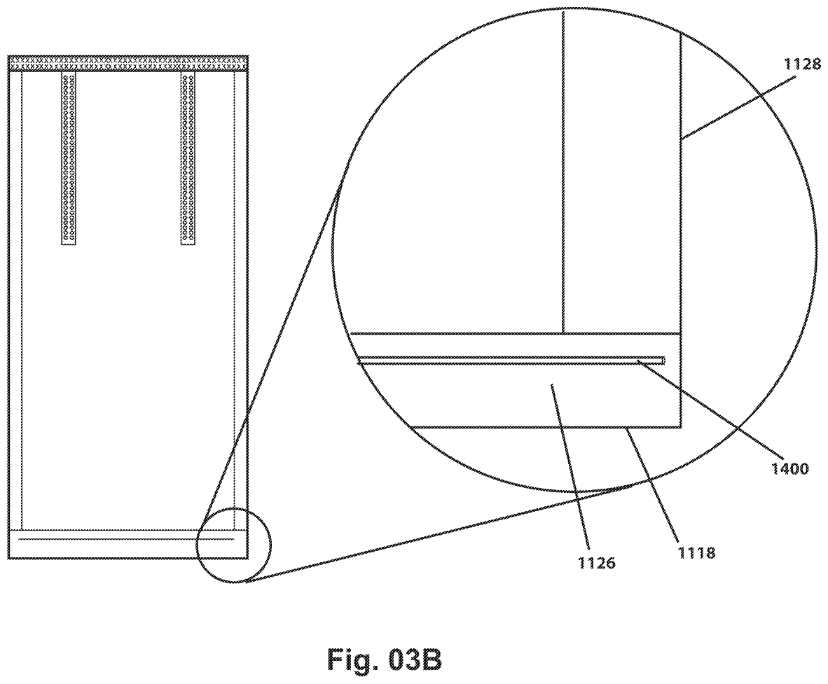

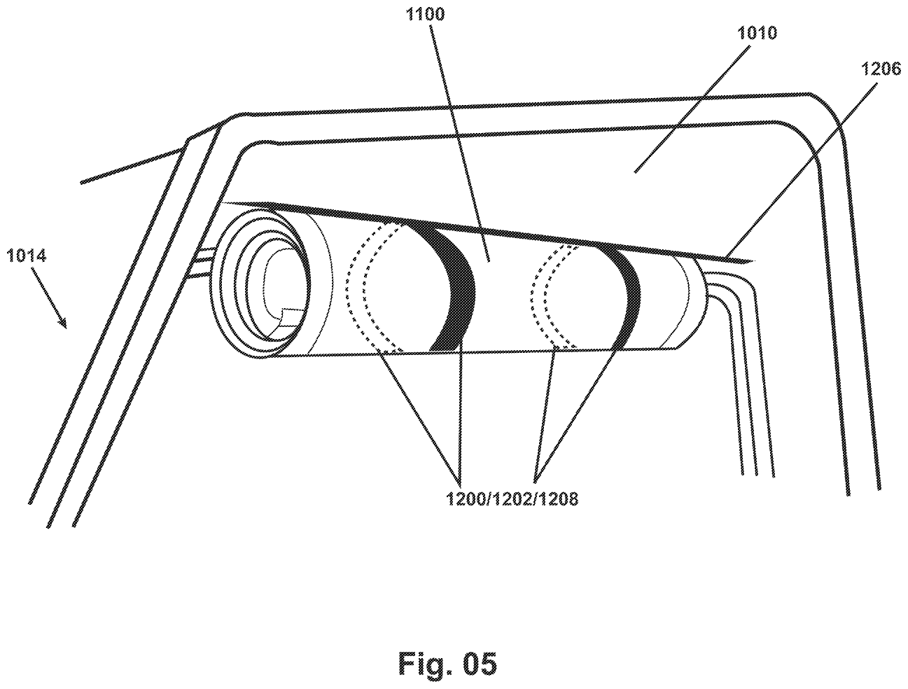

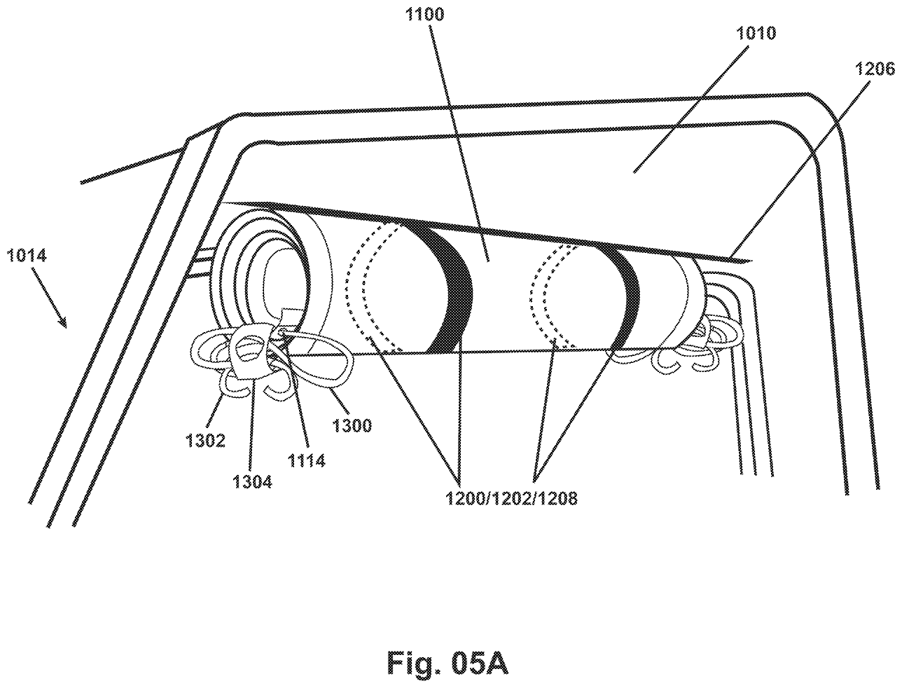

FIG. 3 shows a front view of an embodiment of flexible plastic sheet 1100. Flexible plastic sheet 1100 is shown as having substantially rectangular shape 1116 and having flexible-plastic-sheet first length 1120 and flexible-plastic-sheet second length 1122. In an embodiment, first length 1120 is greater than second length 1122. Persons of ordinary skill in the art will be able to determine useful first and second lengths 1120 and 1122 without having to exercise undue experimentation. Any useful first and second lengths 1120 and 1122 (depending on the size and shape of golf cart 1000) can be employed. In an embodiment, first length 1122 ranges from 33 to 42 inches, and second length 1122 ranges from 14 to 22 inches. In another embodiment, first length 1120 ranges from 30 to 50 inches, and second length 1122 ranges from 12 to 25 inches. FIG. 3 further shows flexible plastic sheet 1100 having four edge portions 1118 and, namely, flexible-plastic-sheet edge portion 1106 (that is configured to attach to golf-cart roof 1010) having first hook-and-loop fastener strip 1204 attached thereto. Flexible-plastic-sheet first-length folds or creases 1128 are created by folding a first-length edge back upon itself one time, and then after creating fold or crease 1128, fold or crease 1128 is secured in first-length folded position 1124 using an adhesive, glue, stitches, welding, or combinations thereof. Third hook-and-loop fastener strips 1208 are shown in a position that is substantially perpendicular to first hook-and-loop fastener strip 1204. Flexible-plastic-sheet first side 1108 and flexible-plastic-sheet second side 1110 (using a circular arrow to indicate the second side of flexible-plastic-sheet 1100) are identified, and third hook-and-loop fastener strip 1208 is shown on flexible-plastic-sheet first side 1108. The positions of fourth hook-and-loop fastener strips 1210 (although visibly obstructed due to the position of the third hook-and-loop fastener strip 1208) are shown with phantom lines as being positioned on flexible-plastic-sheet second side 1110 and overlapping (on second side 1110) with the third hook-and-loop fastener strips 1208 on flexible-plastic-sheet first side 1108. It is because of the positions of third and fourth hook-and-loop fastener strips 1208, 1210 on opposite sides of flexible plastic sheet 1100 that third and fourth hook-and-loop fastener strips 1208, 1210 naturally contact each other, mate, and attach to one another when flexible plastic sheet 1100 is rolled up into a stowed position underneath golf-cart roof 1010 (as shown in FIG. 05). Flexible-plastic-sheet second-length folded position 1126 is created by folding a second-length edge back upon itself one time, and then after creating fold or crease 1130, fold or crease 1130 is secured in second-length folded position 1126 using an adhesive, glue, stitches, welding, or combinations thereof. In an embodiment, at least one substantially straight wire 1400 is position inside the fold of second-length folded position 1126; wire 1400 helps to maintain a substantially straight second-length folded position 1126.

FIG. 03A shows a perspective view of an upper-end portion of flexible plastic sheet 1100 in a curved configuration. From this view, first hook-and-loop fastener strip 1204 is shown as being attached to flexible-plastic-sheet edge portion 1106. Flexible-plastic-sheet second side 1110 has fourth hook-and-loop fastener strip 1210 attached thereto, and flexible-plastic-sheet first side 1108 has third hook-and-loop fastener strip 1208 attached thereto. Flexible-plastic-sheet edge portion 1118 and flexible-plastic-sheet first-length folded position 1124 are as described above.

FIG. 03B is a magnified view of a bottom-corner portion of flexible plastic sheet 1100. The magnified view shows wire 1400 within flexible-plastic-sheet second-length folded position 1126. Flexible-plastic-sheet first-length fold 1128 and flexible-plastic-sheet edge portion 1118 are also shown.

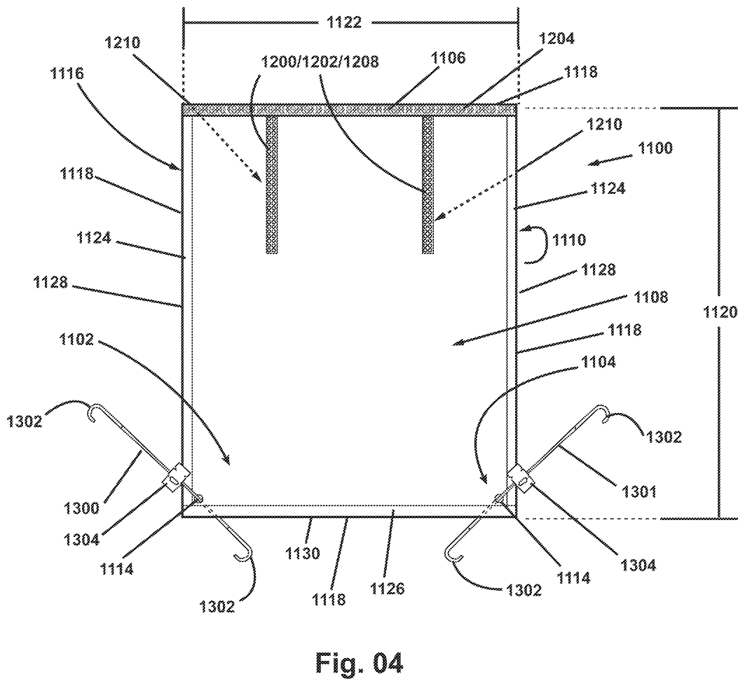

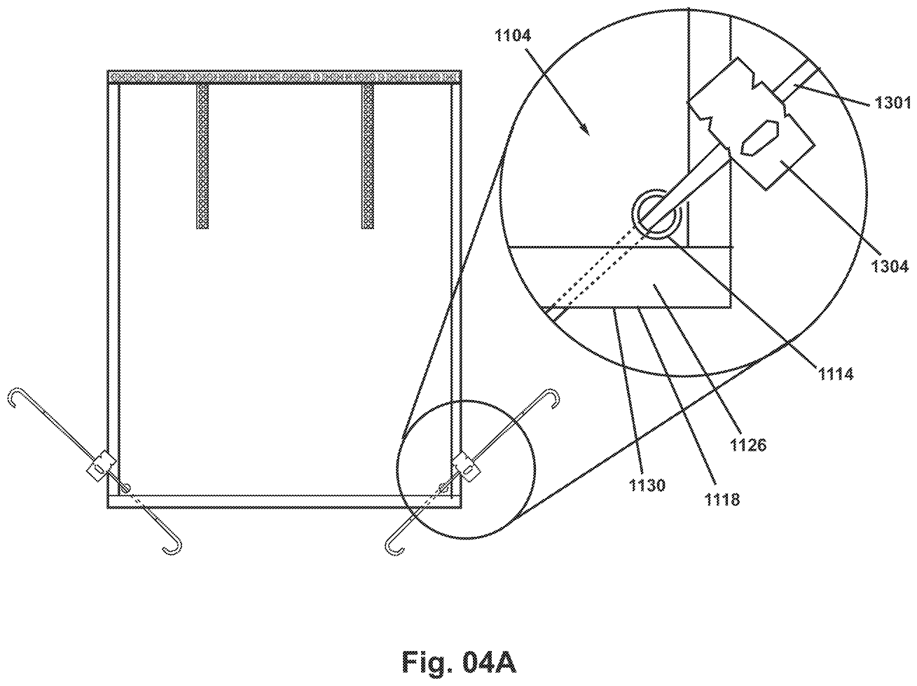

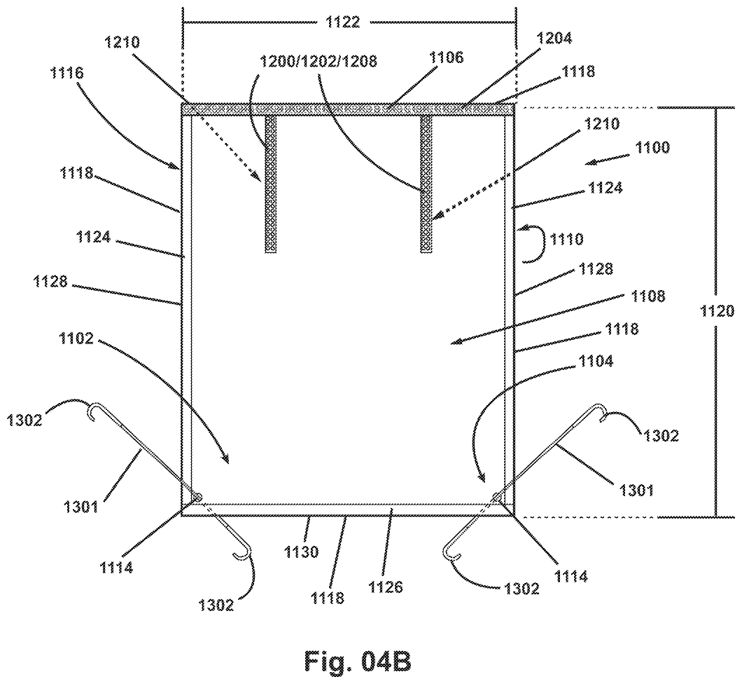

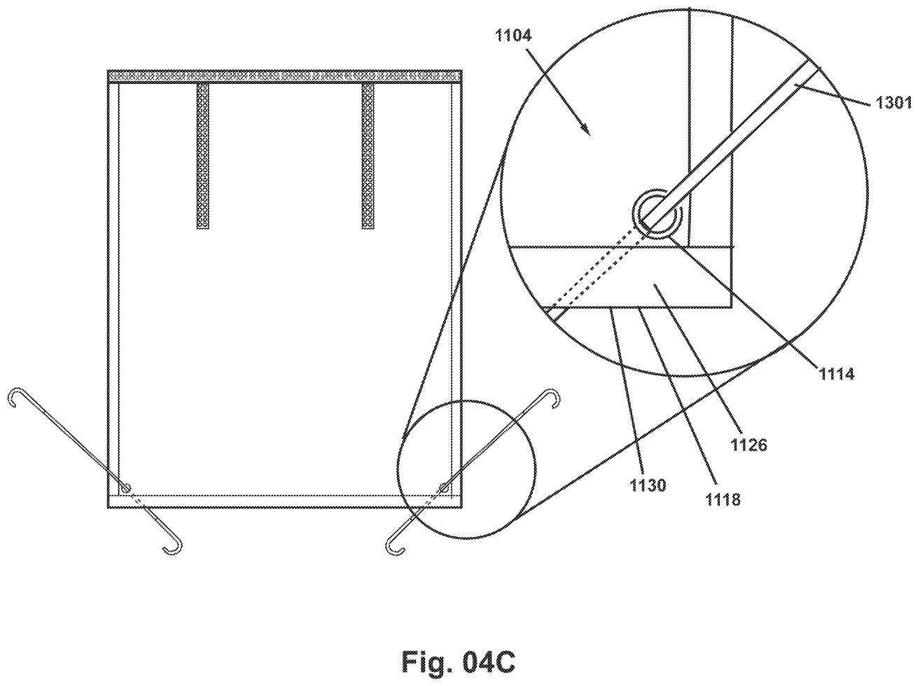

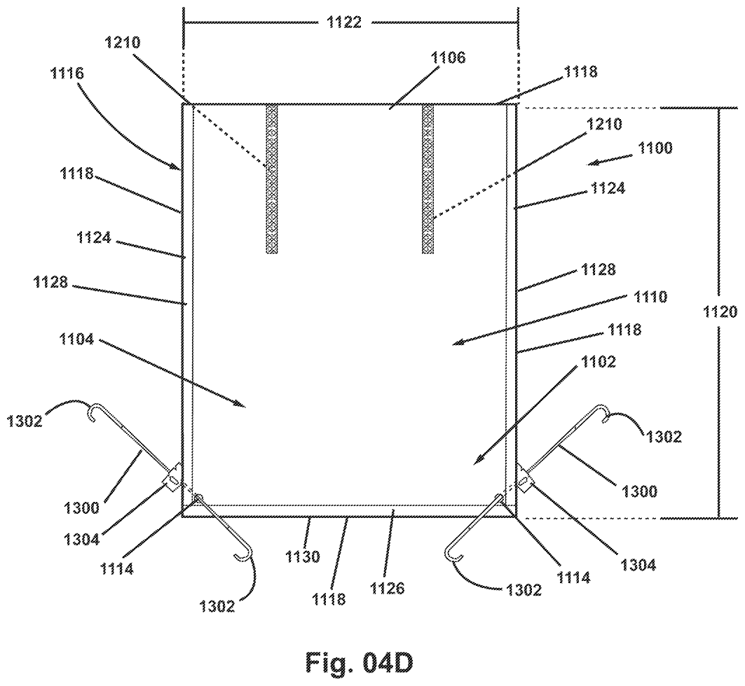

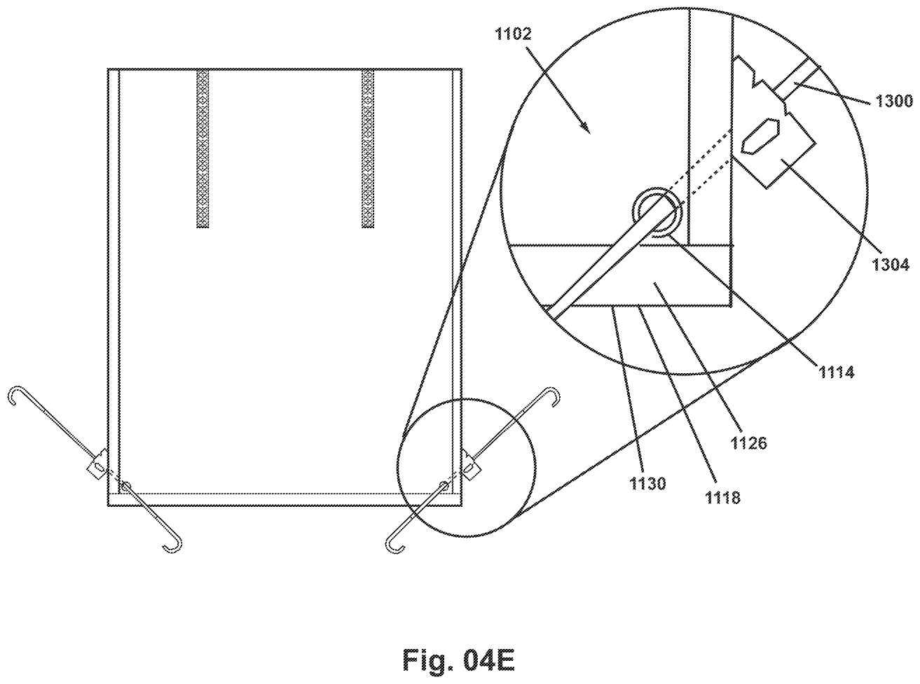

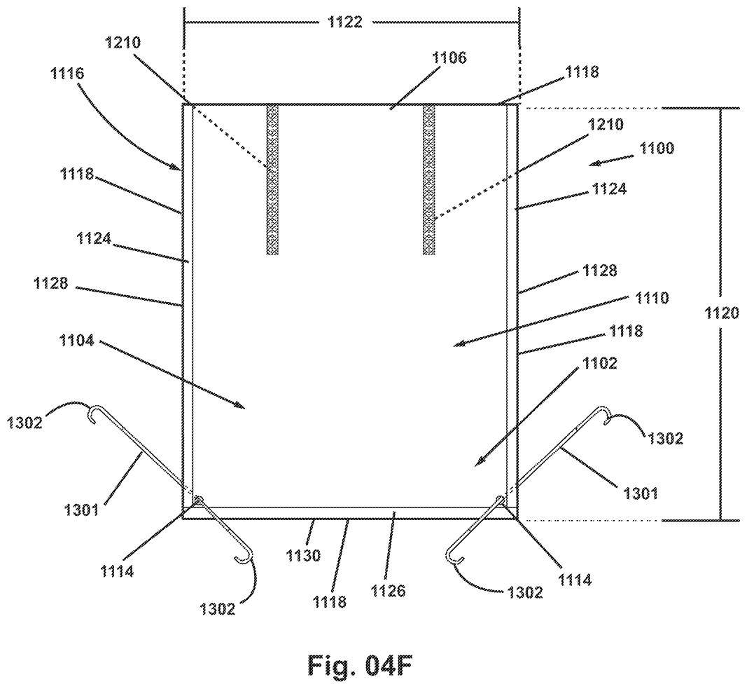

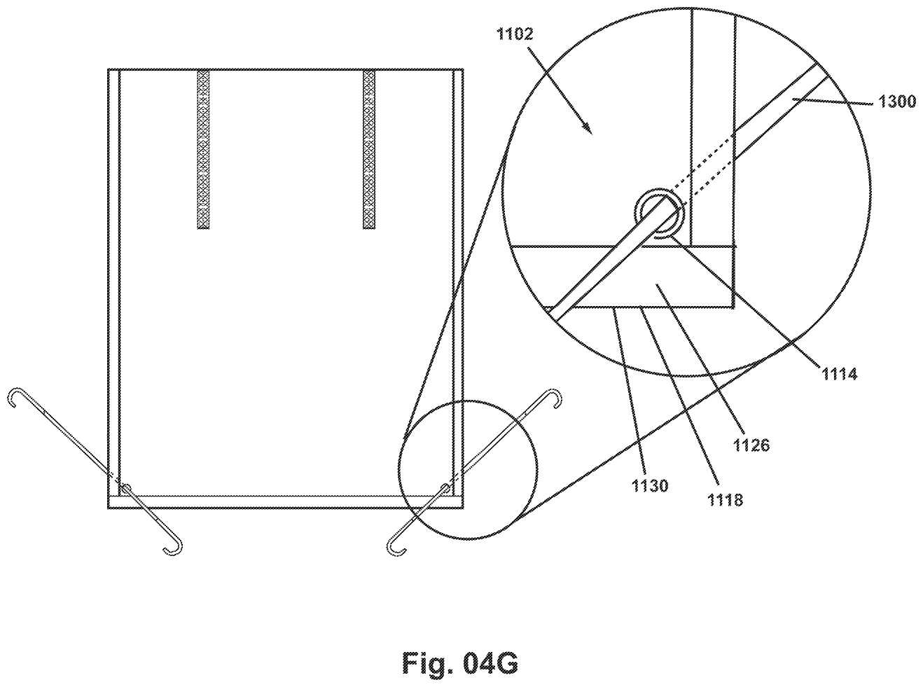

FIG. 4 shows a front view of an additional embodiment of flexible plastic sheet 1100. Flexible plastic sheet 1100 is shown as having substantially rectangular shape 1116 and having flexible-plastic-sheet first length 1120 and flexible-plastic-sheet second length 1122. In an embodiment, first length 1120 is greater than second length 1122. Persons of ordinary skill in the art will be able to determine useful first and second lengths 1120 and 1122 without having to exercise undue experimentation. Any useful first and second lengths 1120 and 1122 (depending on the size and shape of golf cart 1000) can be employed. In an embodiment, first length 1120 ranges from 30 to 50 inches, and second length 1122 ranges from 20 to 40 inches. In another embodiment, first length 1120 ranges from 25 to 55 inches, and second length 1122 ranges from 15 to 45 inches. FIG. 4 further shows flexible plastic sheet 1100 having four edge portions 1118 and, namely, flexible-plastic-sheet edge portion 1106 (that is configured to attach to golf-cart roof 1010) having first hook-and-loop fastener strip 1204 attached thereto. Flexible-plastic-sheet first-length folds or creases 1128 are created by folding a first-length edge back upon itself one time, and then after creating fold or crease 1128, fold or crease 1128 is secured in first-length folded position 1124 using an adhesive, glue, stitches, welding, or combinations thereof. Third hook-and-loop fastener strips 1208 are shown in a position that is substantially perpendicular to first hook-and-loop fastener strip 1204. Flexible-plastic-sheet first side 1108 and flexible-plastic-sheet second side 1110 (using a circular arrow to indicate the second side of flexible-plastic-sheet 1100) are identified, and third hook-and-loop fastener strip 1208 is shown on flexible-plastic-sheet first side 1108. The positions of fourth hook-and-loop fastener strips 1210 (although visibly obstructed due to the position of the third hook-and-loop fastener strip 1208) are shown with phantom lines as being positioned on flexible-plastic-sheet second side 1110 and overlapping (on second side 1110) with the third hook-and-loop fastener strips 1208 on flexible-plastic-sheet first side 1108. It is because of the positions of third and fourth hook-and-loop fastener strips 1208, 1210 on opposite sides of flexible plastic sheet 1100 that third and fourth hook-and-loop fastener strips 1208, 1210 naturally contact each other, mate, and attach to one another when flexible plastic sheet 1100 is rolled up into a stowed position underneath golf-cart roof 1010 (as shown in FIG. 05A). Flexible-plastic-sheet second-length folded position 1126 is created by folding a second-length edge back upon itself one time, and then after creating fold or crease 1130, fold or crease 1130 is secured in second-length folded position 1126 using an adhesive, glue, stitches, welding, or combinations thereof. Grommets 1114 are located in flexible-plastic-sheet first-corner and second-corner portions 1102, 1104. In flexible-plastic-sheet first-corner portion 1102, front-end bungee cord 1300 passes through grommet 1114 and thereby allows bungee cord 1300 to create tension and attach flexible-plastic-sheet first-corner portion 1102 to golf-cart front-end portion 1006. At either end of front-end bungee cord 1300 is a bungee-cord hook 1302 that enables bungee cord 1300 to be secured to itself or a fixed object on golf-cart front-end portion 1006; bungee-cord securing component 1304 is attached to bungee cord 1300 and configured to secure bungee-cord 1300 in a stowed position when flexible plastic sheet 1100 is also in a stowed position. Likewise, in flexible-plastic-sheet second-corner portion 1104, rear-end bungee cord 1301 passes through grommet 1114 and thereby allows bungee cord 1301 to create tension and attach flexible-plastic-sheet second-corner portion 1102 to golf-cart rear-end portion 1008. At either end of rear-end bungee cord 1301 is a bungee-cord hook 1302 that enables bungee cord 1301 to be secured to itself or a fixed object on golf-cart rear-end portion 1008; bungee-cord securing component 1304 is attached to bungee cord 1301 and configured to secure bungee-cord 1301 in a stowed position when flexible plastic sheet 1100 is also in a stowed position.

FIG. 04A shows a magnified view of flexible-plastic sheet second-corner portion 1104 and how bungee cord 1301 passes from back to front through grommet 1114. The magnified elements are: flexible-plastic-sheet second-length fold 1130, flexible-plastic-sheet edge portion 1118, flexible-plastic-sheet second-length folded position 1126, grommet 1114, bungee-cord securing component 1304, and rear-end bungee cord 1301. FIG. 04C shows a very similar embodiment as FIG. 04A with the exception that in FIG. 04C bungee-cord securing component 1304 is absent from the embodiment.

FIG. 04B shows a very similar embodiment as FIG. 04 with the exception that in FIG. 04B bungee-cord securing component 1304 is absent from the embodiment.

FIG. 04D shows the rear view of the embodiment shown in FIG. 04.

FIG. 04E shows a magnified portion of a rear view of the embodiment portrayed in FIG. 04D; specifically shown in the magnified view of FIG. 04E are: flexible-plastic-sheet first-corner portion 1102, flexible-plastic-sheet second-length fold 1130, flexible-plastic-sheet edge portion 1118, flexible-plastic-sheet second-length folded position 1126, grommet 1114, bungee-cord securing component 1304, and front-end bungee cord 1300.

FIG. 04F shows a very similar embodiment as FIG. 04D with the exception that in FIG. 04F, bungee-cord securing component 1304 is absent from the embodiment.

FIG. 04G shows a very similar embodiment as FIG. 04E with the exception that in FIG. 04G, bungee-cord securing component 1304 is absent from the embodiment.

1. A golf cart comprising:
a golf cart having a driver side, a passenger side, a front-end portion, a rear-end portion, and a roof;
a flexible plastic sheet that partitions the golf-cart driver side from the golf-cart passenger side;
the flexible plastic sheet having a first-corner portion that is attached to the golf-cart front-end portion;
the flexible plastic sheet having a second-corner portion that is attached to the golf-cart rear-end portion; and
the flexible plastic sheet having an edge portion that is attached to the golf-cart roof.

2. The golf cart of claim 1, wherein the flexible plastic sheet is configured to roll up into a stowed position that is adjacent to and underneath the golf-cart roof.

3. The golf cart of claim 2, wherein the golf cart has at least one tie configured to secure the flexible plastic sheet in the stowed position.

4. The golf cart of claim 3, wherein the at least one tie is attached to the flexible plastic sheet.

5. The golf cart of claim 4, wherein the at least one tie is a hook-and-loop fastener.

6. The golf cart of claim 1, wherein the flexible plastic sheet is clear plastic.

7. The golf cart of claim 1, wherein the flexible plastic sheet is a nylon flexible plastic sheet.

8. The golf cart of claim 1, wherein the golf-cart front end includes a front-viewing frame that describes a front-viewing area, and
wherein the first-corner portion of the flexible plastic sheet is attached to the front-viewing frame.

9. The golf cart of claim 1, wherein the first-corner portion of the flexible plastic sheet is attached to the golf-cart front-end portion using a bungee cord.

10. The golf cart of claim 9, wherein the second-corner portion of the flexible plastic sheet is attached to the golf-cart rear-end portion using a bungee cord.

11. The golf cart of claim 1, wherein both the first-corner portion and the second-corner portion of the flexible plastic sheet include a grommet.

12. The golf cart of claim 11, wherein the first-corner portion of the flexible plastic sheet is attached to the golf-cart front-end portion using a bungee cord that passes through the grommet in the first-corner portion of the flexible plastic sheet, and
wherein the second-corner portion of the flexible plastic sheet is attached to the golf-cart rear-end portion using a bungee cord that passes through the grommet in the second-corner portion of the flexible plastic sheet.

13. The golf cart of claim 1, wherein the flexible plastic sheet further comprises:
a substantially rectangular shape having four edge portions, two opposing edge portions having a first length and two different opposing edge portions having a second length, the first length being greater than the second length;
the two opposing edge portions having the first length respectively having been formed by folding the flexible plastic sheet back upon itself one time and secured into the folded position.

14. The golf cart of claim 13, wherein one of the edge portions having the second length has been formed by folding the flexible plastic sheet back upon itself one time and secured into the folded position.

15. The golf cart of claim 14, wherein one of the edge portions having the second length is not folded back upon itself and has a first hook-and-loop fastener strip attached thereto and running parallel to this edge portion, the golf-cart roof having a second hook-and-loop fastener strip attached thereto, and wherein the first hook-and-loop fastener strip mates with the second hook-and-loop fastener strip to thereby attach the flexible plastic sheet to the golf-cart roof.

16. The golf cart of claim 15, further comprising a third hook-and-loop fastener strip attached to a first side of the flexible plastic sheet; and
a fourth hook-and-loop fastener strip attached to a second side of the flexible plastic sheet, the fourth hook-and-loop fastener strip configured to mate with the third hook-and-loop faster strip when the flexible plastic sheet is in a rolled-up stowed position, the third and fourth hook-and-loop fasteners thereby securing the flexible plastic sheet in the stowed position.

17. A golf cart comprising:
a golf cart having a driver side, a passenger side, and a roof;
a flexible plastic sheet that partitions the golf-cart driver side from the golf-cart passenger side, wherein the flexible plastic sheet is configured to roll up into a stowed position that is adjacent to and underneath the golf-cart roof;
the flexible plastic sheet having an edge portion that is attached to the golf-cart roof;
the golf cart having at least one tie configured to secure the flexible plastic sheet in the stowed position.

18. The golf cart of claim 17, wherein the at least one tie is attached to the flexible plastic sheet.

19. The golf cart of claim 18, wherein the at least one tie is a hook-and-loop fastener.

20. The golf cart of claim 17, wherein the flexible plastic sheet has a substantially rectangular shape having four edge portions, two opposing edge portions having a first length and two different opposing edge portions having a second length, the first length being different than the second length;
the two opposing edge portions having the first length respectively having been formed by folding the flexible plastic sheet back upon itself one time and secured into the folded position.

21. The golf cart of claim 20, wherein one of the edge portions having the second length has been formed by folding the flexible plastic sheet back upon itself one time and secured into the folded position.

22. The golf cart of claim 21, wherein the edge portion having a second length and having been formed by folding the flexible plastic sheet back upon itself one time and secured in the folded position, having at least one substantially straight wire inside of the fold, the wire having a length substantially equal to the second length and the wire being parallel to the fold.

23. The golf cart of claim 22, wherein one of the edge portions having the second length is not folded back upon itself and has a first hook-and-loop fastener strip attached thereto and running parallel to this edge portion, the golf-cart roof having a second hook-and-loop fastener strip attached thereto, and wherein the first hook-and-loop fastener strip mates with the second hook-and-loop fastener strip to thereby attach the flexible plastic sheet to the golf-cart roof.

24. The golf cart of claim 23, further comprising a third hook-and-loop fastener strip attached to
a first side of the flexible plastic sheet; and
a fourth hook-and-loop fastener strip attached to a second side of the flexible plastic sheet, the fourth hook-and-loop fastener strip configured to mate with the third hook-and-loop faster strip when the flexible plastic sheet is in a rolled-up stowed position, the third and fourth hook-and-loop fastener strips thereby securing the flexible plastic sheet in the stowed position.

25. A golf-cart partition comprising:
a flexible plastic sheet configured to partition a golf-cart driver side from a golf-cart passenger side;
the flexible plastic sheet being substantially rectangular and having two opposing edges of a first length and two opposing edges of a second length, the first length being greater than the second length;
first and second edges that are opposing and that have the first length, the first and second edges having respectively been formed by folding the flexible plastic sheet back upon itself one time and secured into the resulting folded position;
a third edge having the second length and having been formed by folding the flexible plastic sheet back upon itself one time and secured into the resulting folded position;
the flexible plastic sheet having first and second corners, the first corner being formed by the first edge meeting the third edge and the second corner being formed by the second edge meeting the third edge;
a first grommet in immediate proximity to the first corner;
a second grommet in immediate proximity to the second corner;
the first and second grommet both being configured to allow a bungee cord to pass therethrough;
a first hook-and-loop fastener strip being attached to the fourth edge and configured to mate with a second hook-and-loop fastener strip;
the flexible plastic sheet having a first and second side, the first side having a third hook-and-loop fastener strip attached thereto; and
the third hook-and-loop fastener strip configured to contact and mate with a fourth hook-and-loop fastener strip that is attached to the second side of the flexible plastic sheet when the flexible plastic sheet is in a rolled-up configuration.

26. The golf-cart partition of claim 25 further comprising:
the first side having a fifth hook-and-loop fastener strip attached thereto; and
the fifth hook-and-loop fastener strip configured to contact and mate with a sixth hook-and-loop fastener strip that is attached to the second side of the flexible plastic sheet when the flexible plastic sheet is in a rolled-up configuration.

27. The golf-cart partition of claim 26, wherein the first length ranges from 30-50 inches and the second length ranges from 20-40 inches.

28. A golf-cart partition comprising:
a flexible plastic sheet configured to partition a golf-cart driver side from a golf-cart passenger side;
the flexible plastic sheet being substantially rectangular and having two opposing edges of a first length and two opposing edges of a second length,
the first length being greater than the second length;
first and second edges that are opposing and that have the first length, the first and second edges having respectively been formed by folding the flexible plastic sheet back upon itself one time and secured into the resulting folded position;
a third edge having the second length and having been formed by folding the flexible plastic sheet back upon itself one time and secured into the resulting folded position, wherein at least one wire is inside of the resulting folded position;
the flexible plastic sheet having first and second corners, the first corner being formed by the first edge meeting the third edge and the second corner being formed by the second edge meeting the third edge;
a first hook-and-loop fastener strip being attached to the fourth edge and configured to mate with a second hook-and-loop fastener strip;
the flexible plastic sheet having a first and second side, the first side having a third hook-and-loop fastener strip attached thereto; and
the third hook-and-loop fastener strip configured to contact and mate with a fourth hook-and-loop fastener strip that is attached to the second side of the flexible plastic sheet when the flexible plastic sheet is in a rolled-up configuration.

26. The golf-cart partition of claim 25 further comprising:
the first side having a fifth hook-and-loop fastener strip attached thereto; and
the fifth hook-and-loop fastener strip configured to contact and mate with a sixth hook-and-loop fastener strip that is attached to the second side of the flexible plastic sheet when the flexible plastic sheet is in a rolled-up configuration.

27. The golf-cart partition of claim 26, wherein the first length ranges from 33-42 inches and the second length ranges from 14-22 inches.
